(19) United States
(12) Patent Application Publication
(10) Pub. No.: US 2004/0148381 A1
(43) Pub. Date: Jul. 29, 2004

(54) Dictionary updating system, updating processing server, terminal, control method, program and recording medium

(75) Inventors: Hidenobu Beppu, Yamato-shi (JP); Harumi Itoh, Tokyo-to (JP); Tomohiro Miyahira, Yamato-shi (JP)

Correspondence Address: Gregory M. Doudnikoff, IBM Corporation T81/503, P.O. Box 12195, Research Triangle Park, NC, 27709, US

(73) Assignee: International Business Machines Corporation, Armonk, NY (US)

(21) Appl. No.: 10/740,007

(22) Filed: Dec. 18, 2003

(30) Foreign Application Priority Data
Dec. 24, 2002 (JP) 2002-373122

(51) Int. Cl. G06F 15/173; G06F 9/44

(52) U.S. Cl. 709/223; 717/168

(57) ABSTRACT

A dictionary updating system is provided. In one embodiment, the system comprises a terminal having a first dictionary for converting input conversion source information to conversion destination information and an updating processing server for updating the first dictionary of the terminal via a network. The terminal comprises a first dictionary storage unit for storing the first dictionary, a conversion processing information storage unit for storing conversion processing information obtained during processing of converting the conversion source information to the conversion destination information using the first dictionary, and a conversion processing information transmitting unit for transmitting the conversion processing information to the updating processing server. The updating processing server comprises a dictionary updating information generating unit for generating dictionary updating information for updating the first dictionary according to the conversion processing information and a dictionary updating information transmitting unit for transmitting the dictionary updating information to the terminal.

### BACKGROUND OF THE INVENTION

1. Field of the Invention

The present invention relates to a dictionary updating system, an updating processing server, a terminal, a control method, a program and a recording medium. More particularly, the present invention relates to the dictionary updating system, the updating processing server, the terminal, the control method, the program and the recording medium for updating a dictionary depending on circumstances of usage by a user.

2. Description of the Related Art

Conventionally, in a machine (computer-based) translation system, a user may add new words to the dictionary in order to improve quality of translations. However, the technique by which the user adds the new words to the dictionary has been cumbersome, particularly if the dictionary is divided into a plurality of fields. In such dictioneries, it is usually difficult to select an appropriate field. In view of this a machine translation system was proposed in Japanese Published Unexamined Pagtent Application No. 10-269220 (Patent document 1) which increases convenience for the user by automatically selecting a type of the dictionary to which the word is added.

However, an object of the above described system is to assist the user when he registers the new word to a user dictionary by himself, and the new word may not be added to the user dictionary automatically on the basis of a usage history and the like of the user. In addition, though some general machine translation systems may install additionally field dictionaries, even in such cases, it is necessary for the user to indicate explicitly which field dictionaries are to be installed, and the dictionaries to be installed may not be selected automatically.

Therefore, an object of the present invention is to provide a dictionary updating system, an updating processing server, a terminal, a control method, a program and a recording medium which may solve the above described problems. This object is achieved by combining features according to independent claims in the claims. In addition, dependent claims define further advantageous examples of the present invention.

### SUMMARY OF THE INVENTION

In other words, according to a first embodiment of the present invention, a dictionary updating system including a terminal having a first dictionary for converting input conversion source information to conversion destination information and an updating processing server for updating the first dictionary of the terminal via a network is provided, characterized in that the terminal includes a first dictionary storage unit for storing the first dictionary, a conversion processing information storage unit for storing conversion processing information obtained during processing of converting the conversion source information to the conversion destination information on the basis of the first dictionary, and a conversion processing information transmitting unit for transmitting the conversion processing information to the updating processing server, and the updating processing server includes a dictionary updating information generating unit for generating dictionary updating information for updating the first dictionary on the basis of the conversion processing information, and a dictionary updating information transmitting unit for transmitting the dictionary updating information to the terminal. Also, the above described updating processing server, the above described terminal, a control method for controlling the above described dictionary updating system, a program for realizing the above described dictionary updating system and a recording medium are provided.

According to the present invention, dictionary updating system including a terminal having a first dictionary for converting input conversion source information to conversion destination information and an updating processing server for updating the first dictionary of the terminal via a network, characterized in that the terminal includes: a first dictionary storage unit for storing the first dictionary; a conversion processing information storage unit for storing conversion processing information obtained during processing of converting the conversion source information to the conversion destination information on the basis of the first dictionary; and a conversion processing information transmitting unit for transmitting the conversion processing information to the updating processing server, and the updating processing server includes: a dictionary updating information generating unit for generating dictionary updating information for updating the first dictionary on the basis of the conversion processing information; and a dictionary updating information transmitting unit for transmitting the dictionary updating information to the terminal.

The dictionary updating system may be, characterized in that the updating processing server further includes a second dictionary storage unit for storing a second dictionary for converting the conversion source information to the conversion destination information; and the dictionary updating information generating unit selects information to be added to the first dictionary, from the second dictionary, on the basis of the conversion processing information, and generates the information as the dictionary updating information.

The dictionary updating system may be characterized in that the first dictionary storage unit stores the first dictionary for translating the conversion source information written in a first language to the conversion destination information written in a second language; the conversion processing information storage unit stores information for associating the conversion source information with a certainty factor of a translation result, as the conversion processing information; the updating processing server further includes a translation unit for translating the received conversion source information by means of the second dictionary and outputting the certainty factor of the translation; and if the received certainty factor associated with the conversion source information is lower than the certainty factor in the case of being translated by the translation unit, the dictionary updating information generating unit selects the information used for the translation of the conversion source information by the translation unit, from the second dictionary, and generates the information as the dictionary updating information.

The dictionary updating system may be characterized in that if the certainty factor of the translation in the conversion source information is lower than a predefined reference certainty factor, the conversion processing information storage unit stores the conversion source information.

The dictionary updating system may be characterized in that the conversion processing information storage unit stores the conversion source information which has not been able to be converted with the first dictionary, as the conversion processing information; and the dictionary updating information generating unit selects the conversion destination information corresponding to the conversion processing information as the dictionary updating information from the second dictionary.

The dictionary updating system may be characterized in that the dictionary updating information generating unit further selects the conversion destination information on compound words including the conversion processing information, from the second dictionary.

The dictionary updating system may be characterized in that the first dictionary storage unit stores a plurality of first sub-dictionaries as the first dictionary; the conversion processing information storage unit stores respective frequencies of use of the plurality of first sub-dictionaries as the conversion processing information; the conversion processing information transmitting unit transmits the respective frequencies of use of the plurality of first sub-dictionaries as the conversion processing information to the updating processing server; the second dictionary storage unit stores a plurality of second sub-dictionaries associated with the plurality of first sub-dictionaries respectively, as the second dictionary; and if the frequency of use of one of the first sub-dictionaries is higher than a predefined first frequency, the dictionary updating information generating unit generates one of the second sub-dictionaries corresponding to the one of the first sub-dictionaries, as the dictionary updating information.

The dictionary updating system may be characterized in that the second dictionary includes the first dictionary; and if the frequency of use of another one of the first sub-dictionaries is lower than a predefined second frequency, the dictionary updating information generating unit generates a deletion instruction for deleting the another one of the first sub-dictionaries, as the dictionary updating information.

The dictionary updating system may be characterized in that the updating processing server further includes a capacity management unit for managing capacity information indicating a free capacity in a storage device provided in the terminal; and the dictionary updating information generating unit generates the deletion instruction further on condition that the free capacity indicated by the free capacity information is smaller than a predefined capacity.

The dictionary updating system may be characterized in that the terminal further includes: an E-mail transmitting unit for transmitting the conversion destination information to which the conversion source information has been converted, to an external terminal via an E-mail; the conversion processing information transmitting unit further transmits the E-mail as the conversion processing information to the updating processing server each time the E-mail is transmitted; and the dictionary updating information transmitting unit creates the dictionary updating information on the basis of the E-mail, and transmits it to the terminal.

The dictionary updating system may be characterized in that the conversion processing information transmitting unit generates the conversion processing information by exchanging an word order among a plurality of words in a sentence in the E-mail.

The dictionary updating system may be characterized in that the conversion processing information transmitting unit deletes the conversion processing information stored in the conversion processing information storage unit upon transmitting the conversion processing information to the updating processing server.

The present invention also provides a terminal having a first dictionary for converting input conversion source information to conversion destination information and causing an external updating processing server to update the first dictionary, characterized by including: a conversion processing information storage unit for storing conversion processing information obtained during processing of converting the conversion source information to the conversion destination information on the basis of the first dictionary; a conversion processing information transmitting unit for transmitting the conversion processing information to the updating processing server; and a first dictionary storage unit for storing the first dictionary and updating the first dictionary upon receiving dictionary updating information for updating the first dictionary from the updating processing server.

The terminal may further include a translation unit for translating the conversion source information written in a first language to the conversion destination information written in a second language, by means of the first dictionary, characterized in that the conversion processing information transmitting unit transmits information for associating the conversion source information with a certainty factor of a translation result, as the conversion processing information, to the updating processing server; and the first dictionary storage unit updates the first dictionary on the basis of the dictionary updating information returned by the updating processing server, in response to the certainty factor.

The terminal may be characterized in that the conversion processing information storage unit stores the conversion source information which has not been able to be converted with the first dictionary, as the conversion processing information; and the first dictionary storage unit receives the conversion destination information corresponding to the conversion processing information as the dictionary updating information from the updating processing server, and updates the first dictionary by adding the conversion destination information.

The terminal characterized in that the first dictionary storage unit stores a plurality of first sub-dictionaries as the first dictionary; the conversion processing information storage unit stores respective frequencies of use of the plurality of first sub-dictionaries as the conversion processing information; the conversion processing information transmitting unit transmits the respective frequencies of use of the plurality of first sub-dictionaries as the conversion processing information to the updating processing server; and the first dictionary storage unit receives another one of sub-dictionaries associated with one of the first sub-dictionaries having the frequency of use which is higher than a predefined first frequency, from the updating processing server, and updates the first dictionary by adding the another one of sub-dictionaries.

The present invention may further comprise an updating processing server for transmitting dictionary updating information for updating a first dictionary for converting input conversion source information to conversion destination information to a terminal having the first dictionary, characterized by including: a dictionary updating information generating unit for receiving conversion processing information obtained during processing of converting the conversion source information to the conversion destination information on the basis of the first dictionary from the terminal and generating dictionary updating information for updating the first dictionary on the basis of the conversion processing information; and a dictionary updating information transmitting unit for transmitting the dictionary updating information to the terminal to update the first dictionary.

The present invention futher provides a control method of controlling a terminal having a first dictionary for converting input conversion source information to conversion destination information and an updating processing server for updating the first dictionary of the terminal via a network, characterized by including the steps of: causing the terminal to store the first dictionary; causing the terminal to store conversion processing information obtained during processing of converting the conversion source information to the conversion destination information on the basis of the first dictionary; causing the terminal to transmit the conversion processing information to the updating processing server; causing the updating processing server to generate dictionary updating information for updating the first dictionary on the basis of the conversion processing information; and causing the updating processing server to transmit the dictionary updating information to the terminal.

The invention further provides a program for enabling a computer to serve as an updating processing server for transmitting dictionary updating information for updating a first dictionary for converting input conversion source information to conversion destination information to a terminal having the first dictionary, characterized in that the program enables the computer to serve as: a dictionary updating information generating unit for receiving conversion processing information obtained during processing of converting the conversion source information to the conversion destination information on the basis of the first dictionary from the terminal and generating dictionary updating information for updating the first dictionary on the basis of the conversion processing information; and a dictionary updating information transmitting unit for transmitting the dictionary updating information to the terminal to update the first dictionary.

The present invention further provides a program for enabling a computer to serve as a terminal having a first dictionary for converting input conversion source information to conversion destination information and causing an external updating processing server to update the first dictionary, characterized in that the program enables the computer to serve as: a conversion processing information storage unit for storing conversion processing information obtained during processing of converting the conversion source information to the conversion destination information on the basis of the first dictionary; a conversion processing information transmitting unit for transmitting the conversion processing information to the updating processing server; and a first dictionary storage unit for storing the first dictionary and updating the first dictionary upon receiving dictionary updating information for updating the first dictionary from the updating processing server.

It should be noted that the above described summary of the invention does not list all of necessary features of the present invention, and a subcombination of these feature groups may also be included in the present invention.

### BRIEF DESCRIPTION OF THE DRAWINGS

FIG. 1 is a functional block diagram of a dictionary updating system 10;

FIG. 2 shows an example of a first dictionary storage unit 110 and a second dictionary storage unit 210;

FIG. 3 shows an example of a conversion processing information storage unit 130;

FIG. 4 is an operational flow chart of the dictionary updating system 10;

FIG. 5 is a flow chart showing details of S120;

FIG. 6 shows an example of calculating a certainty factor;

FIG. 7 is a flow chart showing details of S220 shown in FIG. 4;

FIG. 8 is a flow chart showing an example of details of S230 shown in FIG. 4;

FIG. 9 is a functional block diagram of the dictionary updating system 10 in a variation of this embodiment;

FIG. 10 is an operational flow chart of the dictionary updating system 10 in the variation;

FIG. 11 shows an example of a hardware configuration of an updating processing server 200 according to this embodiment and the variation; and

FIG. 12 shows an example of a hardware configuration of a terminal 100 according to this embodiment and the variation.

### DESCRIPTION OF THE PREFERRED EMBODIMENT

Though the present invention will be described below through embodiments of the invention, the following embodiments do not limit the present invention according to the claims, and all combinations of features described in the embodiments are not necessarily required for solution of the present invention.

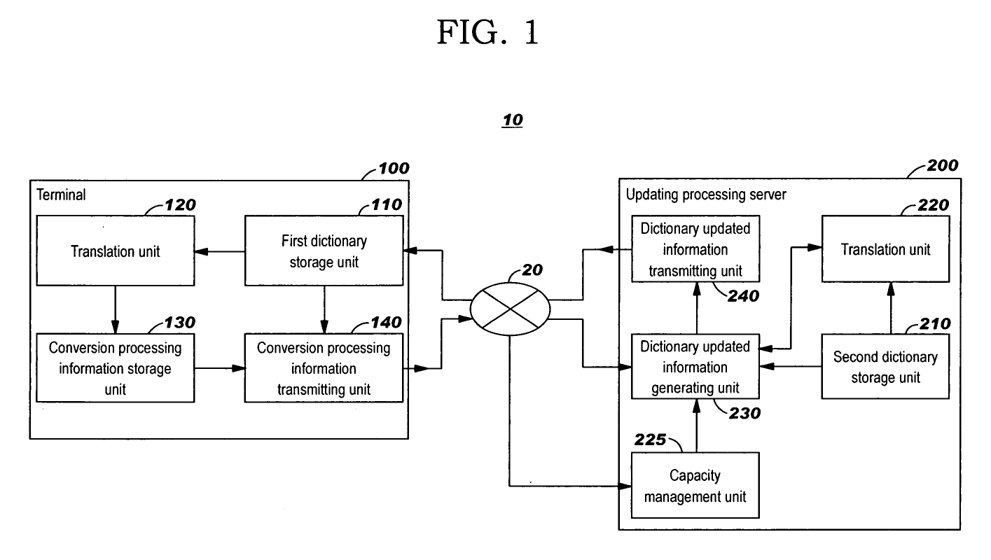

FIG. 1 shows a functional block diagram of a dictionary updating system 10. The dictionary updating system 10 is provided with a terminal 100 having a first dictionary for converting input conversion source information to conversion destination information, and an updating processing server 200 for updating the first dictionary of the terminal 100 via a network 20. The terminal 100 is, for example, a portable communication terminal such as a PDA, and is connected to the updating processing server 200 via the network 20 including a wireless communication network and the Internet. The terminal 100 may communicate with the updating processing server 200 by means of a protocol such as HTTP or FTP, or may communicate with the updating processing server 200 with means such as an E-mail. Alternatively, the terminal 100 may also be connected to the updating processing server 200 via an I/O port such as USB, as the network 20.

The terminal 100 has the first dictionary to be used in processing of converting words, as represented by a machine translation and the like. The terminal 100 translates by means of the first dictionary in response to an instruction from a user, and stores conversion processing information indicating a translation result, for example, the words to be translated in the case where the translation has failed, and the like. The updating processing server 200 may update the first dictionary according to the conversion processing information to improve quality of translation thereafter.

The terminal 100 has a first dictionary storage unit 110, a translation unit 120, a conversion processing information storage unit 130 and a conversion processing information transmitting unit 140. The first dictionary storage unit 110 stores the first dictionary for translating the conversion source information written in a first language to the conversion destination information written in a second language. Alternatively, the first dictionary storage unit 110 may also store a kana-kanji conversion dictionary for converting the conversion source information written in kana to the conversion destination information including kanji, as the first dictionary. For example, the first language may be English, and the second language may be Japanese. In this case, the first dictionary storage unit 110 stores the first dictionary for translating English to Japanese. Alternatively, the first dictionary may also be a Japanese-English dictionary, or a dictionary for translating among a plurality of other languages.

Then, the first dictionary storage unit 110 receives dictionary updating information for updating the first dictionary from a dictionary updating information transmitting unit 240, and updates the first dictionary according to the above described dictionary updating information. The dictionary updating information is, for example, a combination of the conversion source information and the conversion destination information to be added newly to the first dictionary.

The translation unit 120 translates the conversion source information to the conversion destination information using the first dictionary. The translation unit 120 may also perform kana-kanji conversion on the conversion source information using the first dictionary, and generate the conversion destination information. Then the translation unit 120 transmits the conversion processing information obtained during processing of translating to the conversion processing information storage unit 130. The conversion processing information is log information generated during the translation, and a typical example is the conversion source information which has not been able to be translated because it is not registered in the first dictionary. The conversion processing information storage unit 130 receives the conversion processing information from the translation unit 120, and transmits it to the conversion processing information transmitting unit 140. The conversion processing information transmitting unit 140 transmits the received conversion processing information to a dictionary updating information generating unit 230 via the network 20.

With respect to timing for transmitting the conversion processing information, for example, the conversion processing information transmitting unit 140 transmits the conversion processing information when it is received the instruction from the user. Alternatively, the conversion processing information transmitting unit 140 may transmit the conversion processing information each time the conversion processing information is updated in the conversion processing information storage unit 130, or may transmit the conversion processing information periodically for each predefined time, or may transmit the conversion processing information each time charging of a battery provided in the terminal 100 is started, or may transmit the conversion processing information if it is connected to a connecting device (cradle and the like) for communicating with the outside.

The updating processing server 200 has a second dictionary storage unit 210, a translation unit 220, a capacity management unit 225, the dictionary updating information generating unit 230, and the dictionary updating information transmitting unit 240. The second dictionary storage unit 210 stores a second dictionary for generating the conversion destination information from the conversion source information. The translation unit 220 translates the conversion source information received from the dictionary updating information generating unit 230 using the second dictionary obtained from the second dictionary storage unit 210, associates a certainty factor indicating probability of correct translation with the above described conversion source information, and outputs them to the dictionary updating information generating unit 230.

The capacity management unit 225 manages free capacity information indicating a free capacity in a storage device provided in the terminal 100, and transmits it to the dictionary updating information generating unit 230. For example, the capacity management unit 225 may receive the free capacity information periodically from the terminal 100, or may calculate the free capacity estimated on the basis of the size of data transmitted from the updating processing server 200 to the terminal 100, as the free capacity information.

The dictionary updating information generating unit 230 generates the dictionary updating information for updating the first dictionary by selecting it from the second dictionary storage unit 210, according to the conversion processing information received by the conversion processing information transmitting unit 140. For example, dictionary updating information generating unit 230 causes the translation unit 220 to translate the conversion source information included in the conversion processing information, selects data used for the translation by the translation unit 220 from the second dictionary storage unit 210, and generates it as the dictionary updating information to be added to the first dictionary. Furthermore, the dictionary updating information generating unit 230 may also generate a deletion instruction for deleting a portion of the first dictionary, as the dictionary updating information, on the basis of the free capacity information received from the capacity management unit 225. Then the dictionary updating information generating unit 230 transmits the generated dictionary updating information to the dictionary updating information transmitting unit 240. The dictionary updating information transmitting unit 240 transmits the received dictionary updating information to the first dictionary storage unit 110 via the network 20.

It should be noted that the dictionary updating information may also include the first dictionary which has been already stored in the first dictionary storage unit 110, in addition to the information to be added to the first dictionary. In this case, the dictionary updating information generating unit 230 generates both of the information to be added to the first dictionary and the first dictionary which has been already stored in the first dictionary storage unit 110, as the dictionary updating information for updating the first dictionary. In other words, since the first dictionary storage unit 110 may update the first dictionary simply by replacing the received dictionary updating information with the first dictionary, it is possible to simplify processing at the terminal 100.

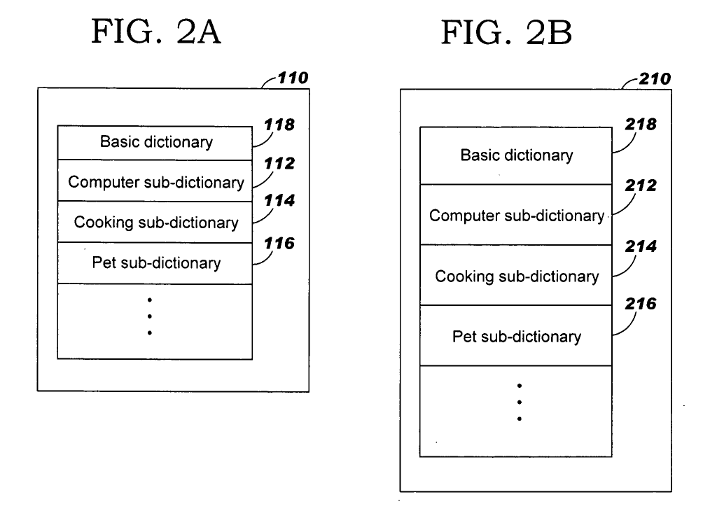

FIG. 2 shows an example of the first dictionary storage unit 110 and the second dictionary storage unit 210, and FIG. 2(a) shows the first dictionary to be stored in the first dictionary storage unit 110. The first dictionary storage unit 110 stores a plurality of first sub-dictionaries as the first dictionary, for example, a basic dictionary 118, a computer sub-dictionary 112, a cooking sub-dictionary 114 and a pet sub-dictionary 116. In addition, FIG. 2(b) shows the second dictionary to be stored in the second dictionary storage unit 210. The second dictionary storage unit 210 stores a plurality of second sub-dictionaries associated with the plurality of first sub-dictionaries respectively, as the second dictionary, for example, a basic dictionary 218, a computer sub-dictionary 212, a cooking sub-dictionary 214 and a pet sub-dictionary 216. The basic dictionary 118 and the basic dictionary 218 store, for example, pronouns, basic verbs, and basic words, compound words and grammar rules, respectively.

The basic dictionary 218, the computer sub-dictionary 212, the cooking sub-dictionary 214 and the pet sub-dictionary 216 may store the words in the same domains, or may be associated with the same identification information, as those of the basic dictionary 118, the computer sub-dictionary 112, the cooking sub-dictionary 114 and the pet sub-dictionary 116 respectively. For example, each of the computer sub-dictionary 212 and the computer sub-dictionary 112 is a computer domain sub-dictionary for storing the words in a computer domain. In addition, as an example of the identification information, each of the computer sub-dictionary 212 and the computer sub-dictionary 112 may be associated with a domain name of “computer”, or may be associated with an identification number, for example, “0001”, indicating that it is the computer domain sub-dictionary. In other words, the dictionary updating information generating unit 230 may identify easily the association of the second sub-dictionaries and the first sub-dictionaries by retrieving the domain name or the identification number.

In addition, the second dictionary includes the first dictionary, and the basic dictionary 218, the computer sub-dictionary 212, the cooking sub-dictionary 214 and the pet sub-dictionary 216 may include the basic dictionary 118, the computer sub-dictionary 112, the cooking sub-dictionary 114 and the pet sub-dictionary 116 respectively. For example, the computer sub-dictionary 112 is created by selecting only the basic words having a high frequency of use among the words in the computer domain stored in the computer sub-dictionary 212.

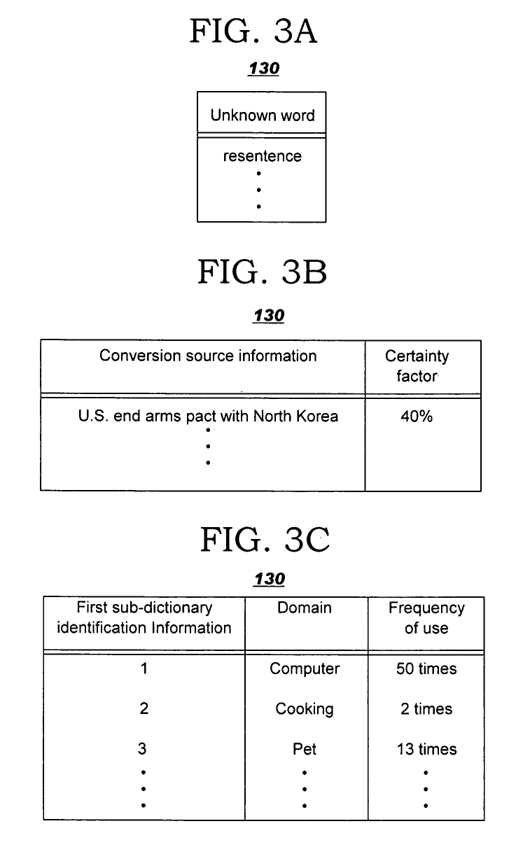

In this way, the second sub-dictionaries to be stored in the second dictionary storage unit 210 are associated with the first sub-dictionaries to be stored in the first dictionary storage unit 110. Accordingly, the dictionary updating information generating unit 230 as will be described below, may select the second sub-dictionaries associated with the first sub-dictionaries appropriately. For example, as will be described in explanation of FIG. 3(c), if the frequency of use of one of the first sub-dictionaries is higher than a predefined frequency, the dictionary updating information generating unit 230 may select the second sub-dictionary associated with this one of the first sub-dictionaries appropriately, and add it to the first dictionary.

It should be noted that the embodiment of classifying the dictionary into the plurality of sub-dictionaries is not limited to the embodiment shown in this figure. For example, the first dictionary storage unit 110 may also store the plurality of first sub-dictionaries classified with respect to degrees of the frequencies of use.

FIG. 3 shows an example of the conversion processing information storage unit 130. In FIG. 3(a), the conversion processing information storage unit 130 stores the conversion source information which has not been able to be converted with the first dictionary, that is, unknown words, as the conversion processing information. If the translation unit 120 detects any unknown words during a translation process, as shown in this figure, it stores the unknown words as the conversion processing information in the conversion processing information storage unit 130. In this case, the dictionary updating information generating unit 230 selects the conversion destination information corresponding to the unknown words from the second dictionary as the dictionary updating information, and transmits them. Accordingly, since the first dictionary storage unit 110 adds the conversion destination information corresponding to the unknown words to the first dictionary, it is possible to translate appropriately the words detected as the unknown words in subsequent translation processes.

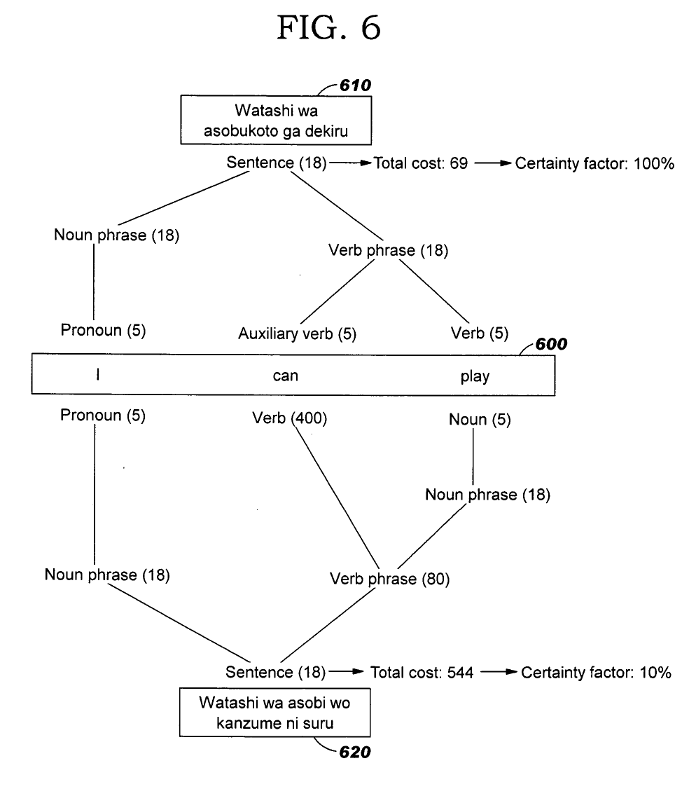

In FIG. 3(b), the conversion processing information storage unit 130 associates a sentence to be translated as the conversion source information with the certainty factor of the translation result, and stores them. The certainty factor of the translation is a numerical value representative of a measure of the probability of correct translation, and an example of a method of calculating it will be described below in FIG. 6. The translation unit 120 associates the sentence to be translated with the certainty factor of the translation and stores them sequentially in the conversion processing information storage unit 130, each time it translates the sentence to be translated. Then the translation unit 220 translates the received sentence to be translated using the second dictionary, and outputs the certainty factor of the translation to the dictionary updating information generating unit 230. If the certainty factor associated with the sentence to be translated and received from the conversion processing information transmitting unit 140, is lower than the certainty factor in the case of being translated by the translation unit 220, the dictionary updating information generating unit 230 selects the information used for the translation by the translation unit 220, from the second dictionary, and transmits the information as the dictionary updating information to the first dictionary storage unit 110. According to the information, the first dictionary storage unit 110 may add the information to the first dictionary for translating with a higher certainty factor.

In FIG. 3(c), the conversion processing information storage unit 130 associates domain identification information indicating the domains of the plurality of first sub-dictionaries and the frequencies of use of the above described first sub-dictionaries with first sub-dictionary identification information for identifying the above described respective plurality of first sub-dictionaries, and stores them. The frequency of use is, for example, the number of times of using the first sub-dictionary up to now since it has been updated before. Alternatively, the frequency of use may also be the number of times of being used within a predefined period. The number of times of using the first sub-dictionary may be, for example, the number of times of using the words stored in the first sub-dictionary for the translation, or may be the number of sentences translated using of the first sub-dictionary.

In addition, in an embodiment in which the translation unit 120 uses the plurality of first sub-dictionaries associated with usage priorities respectively, for the translation, the frequency of use may be the number of times calculated as follows. The translation unit 120 selectively uses the plurality of first sub-dictionaries depending on their usage priorities. For example, if the same conversion source information has been registered in both of one of the first sub-dictionaries having a high usage priority and another one of the first sub-dictionaries having a low usage priority, the translation unit 120 assign the conversion source information according to the one of the first sub-dictionaries having the high usage priority to the translation result. Then, the translation unit 120 modifies the usage priority for each sentence to be translated, in response to the translation result and the instruction from the user and the like, in order to improve the quality of translation. In this case, the translation unit 120 stores the number of sentences translated in the case where the usage priority of the one of the first sub-dictionaries is the highest among all of the first sub-dictionaries, as the frequency of use of the above described one of the first sub-dictionaries, in the conversion processing information storage unit 130.

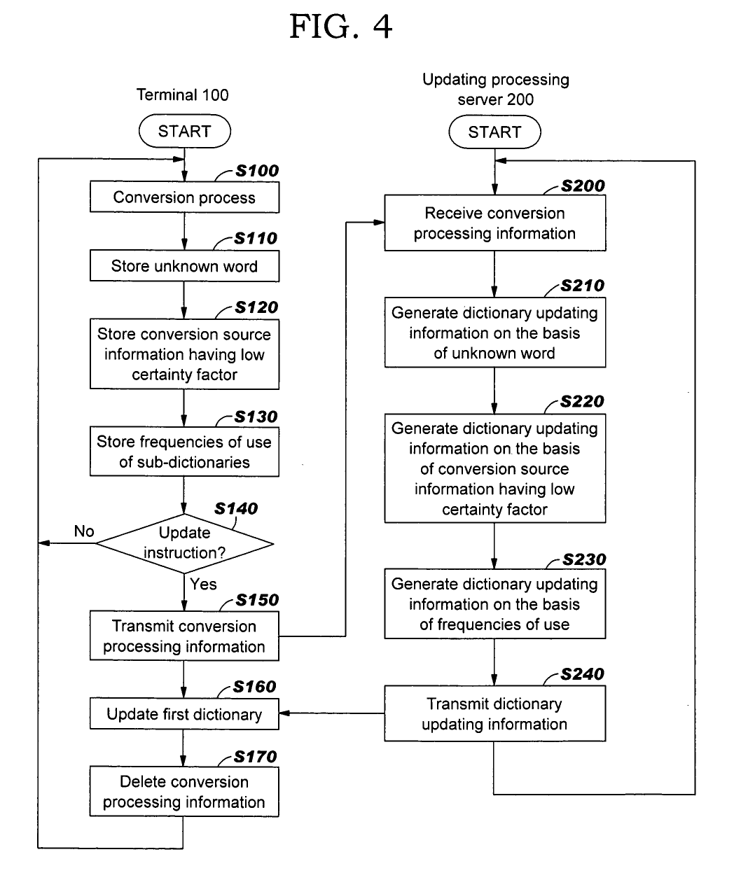

FIG. 4 shows an operational flow of the dictionary updating system 10. The translation unit 120 converts the input conversion source information to the conversion destination information using the first dictionary (S100). Then in response to the translation result by the translation unit 120, the conversion processing information storage unit 130 stores the unknown words, which is an example of the conversion source information which has not been able to be converted with the first dictionary, as the conversion processing information (S110). If the certainty factor of the translation is lower than a predefined reference certainty factor, the conversion processing information storage unit 130 associates the above described conversion source information corresponding to the above described certainty factor, for example, the sentence to be translated, with the certainty factor, and stores them as the conversion processing information (S120). Alternatively, the conversion processing information storage unit 130 may select and store a predefined number of the conversion source information in ascending order of the certainty factor, or may store all of the conversion source information if there is any free capacity in the conversion processing information storage unit 130.

Subsequently, the conversion processing information storage unit 130 associates the frequencies of use of the respective plurality of first sub-dictionaries with the information for identifying the respective first sub-dictionaries, and stores them as the conversion processing information (S130).

If the conversion processing information transmitting unit 140 does not receive an update instruction from the user for starting an updating process of the first dictionary (S140: NO), it returns this process to S100. On the other hand, if the conversion processing information transmitting unit 140 receives the update instruction from the user (S140: YES), it obtains all of the conversion processing information stored in the conversion processing information storage unit 130, and transmits them to the dictionary updating information generating unit 230 (S150).

The dictionary updating information generating unit 230 receives the conversion processing information from the conversion processing information transmitting unit 140 (S200). Then, if the dictionary updating information generating unit 230 receives unknown words as the conversion processing information, it generates the dictionary updating information by selecting the conversion destination information corresponding to the unknown words from the second dictionary (S210). For example, if the dictionary updating information generating unit 230 receives the unknown word of an English word “resentence” as the conversion processing information, it generates both of a verb “saihanketsu-wo-kudasu” and a noun “saihanketsu” as the conversion destination information corresponding to the unknown word, as the dictionary updating information. Furthermore, the dictionary updating information generating unit 230 generates the dictionary updating information by selecting the conversion destination information on the compound word including the unknown word from the second dictionary. For example, if an English word “toxicity” is the unknown word, the dictionary updating information generating unit 230 generates the conversion destination information on the compound words such as “acute toxicity”, “toxicity equivalency factor” and the like, as the dictionary updating information.

In addition, if the dictionary updating information generating unit 230 receives the conversion source information having the certainty factor which is lower than the reference certainty factor, as the conversion processing information, it generates the dictionary updating information on the basis of the above described conversion source information (S220). In addition, if the dictionary updating information generating unit 230 receives the frequencies of use associated with the identification information for identifying the first sub-dictionaries, as the conversion processing information, it generates the dictionary updating information on the basis of the above described frequencies of use (S230). Then, the dictionary updating information transmitting unit 240 transmits the generated dictionary updating information to the first dictionary storage unit 110 (S240). The updating processing server 200 repeats a series of processes as described above, each time it receives the conversion processing information.

If the first dictionary storage unit 110 receives the dictionary updating information for updating the first dictionary from the updating processing server 200, it updates the first dictionary according to the above described dictionary updating information (S160). For example, if the first dictionary storage unit 110 receives the conversion destination information corresponding to unknown words, it adds the above described conversion destination information to the first dictionary. In addition, if the first dictionary storage unit 110 receives the dictionary updating information in response to the certainty factor generated at S120, from the updating processing server 200, it adds the words included in the above described dictionary updating information to the first dictionary. In addition, if the first dictionary storage unit 110 receives the second sub-dictionary associated with the one of the first sub-dictionaries having the frequency of use which is higher than a predefined first frequency, from the updating processing server 200, it adds the above described second sub-dictionary to the first dictionary.

Then if the conversion processing information transmitting unit 140 transmits the conversion processing information to the updating processing server 200, it deletes the conversion processing information stored in the conversion processing information storage unit 130 (S170). After the conversion processing information transmitting unit 140 transmits the conversion processing information (S150) and before it updates the first dictionary (S160), the conversion processing information may be deleted. However, the conversion processing information transmitting unit 140 desirably deletes the conversion processing information after the first dictionary is updated, in order to retain the conversion processing information until it confirms that the dictionary has been updated appropriately.

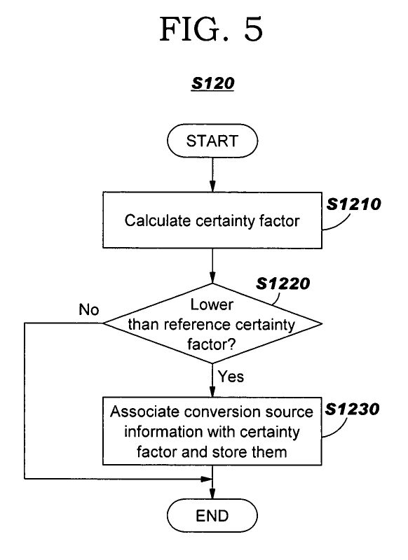

FIG. 5 shows details of S120 shown in FIG. 4. The translation unit 120 calculates the certainty factor of the translation in the conversion source information (S1210). For example, the translation unit 120 calculates the certainty factor of the translation in the numerical value from 100% indicating that the certainty factor is the highest to 0% indicating that the certainty factor is the lowest. Then, if the certainty factor of the translation in the conversion source information is lower than the predefined reference certainty factor (S1220: YES), the conversion processing information storage unit 130 associates the above described conversion source information with the certainty factor, and stores them (S1230).

FIG. 6 shows an example of calculating the certainty factor, that is, details of S1210 in FIG. 5. If the translation unit 120 translates an English sentence 600 “I can play” into a Japanese sentence 610 “Watashi wa asobukoto ga dekiru” in English-Japanese translation, it calculates the certainty factor as 100%. On the other hand, if the translation unit 120 translates the English sentence 600 “I can play” into a Japanese sentence 620 “Watashi wa asobi wo kanzume ni suru”, it calculates the certainty factor as 10%. A process of calculating the certainty factor will be shown below. It should be noted that description of a process in which the translation unit 220 outputs the certainty factor is omitted because it is also approximately the same process described in this figure.

First, in association with each English word, for each part of speech which the above described English word is used as, a cost indicating a low degree of the frequency of use is predefined. For example, the cost of an English word “can” in the case of being used as an auxiliary verb is 5, and the cost thereof in the case of being used as the verb is 400. In this figure, the above described costs are indicated in parentheses following each word class name. Similarly, the cost is also previously associated with a rule for configuring each phrase. For example, the cost of a rule for integrating the auxiliary verb and the verb as a verb phrase is 18.

When the translation unit 120 receives the English sentence 600 to be translated, it analyzes the English sentence 600 with all combinations of parts of speech. Then with respect to a plurality of parts of speech, the translation unit 120 generates the phrases with all combinations which are possible according to the grammar rules. With respect to all of the respective sentences analyzed as described above, the translation unit 120 calculates total costs respectively. For example, the cost in the case of translating the English sentence 600 into the Japanese sentence 610 is calculated by an equation “5+5+5+18+18+18” as 69. On the other hand, the cost in the case of translating the English sentence 600 into the Japanese sentence 620 is calculated by an equation “5+400+5+18+80+18+18” as 544. Then the translation unit 120 generates the conversion destination information according to a method of selecting a sentence having the least cost among all of the sentences and the like.

The translation unit 120 calculates the certainty factor of the translation from the cost used in the generation of the conversion destination information, on the basis of conditions as follows:

(Condition 1) if the cost is not greater than 150, the certainty factor is 100%;

(Condition 2) if the sentence is not parseable (parsing fails and the like), the certainty factor is 0%; and

(Condition 3) otherwise the certainty factor is the value of 100% minus (the cost÷the number of words), where the lowest is 10%.

Accordingly, the translation unit 120 calculates the certainty factor of the Japanese sentence 610 as 100%, and the certainty factor of the Japanese sentence 620 as 10%, respectively. The cost calculation and the method of calculating the certainty factor as described above are only examples, and the method may also be replaced with other method of selecting a result which is the most likely among a plurality of translation results.

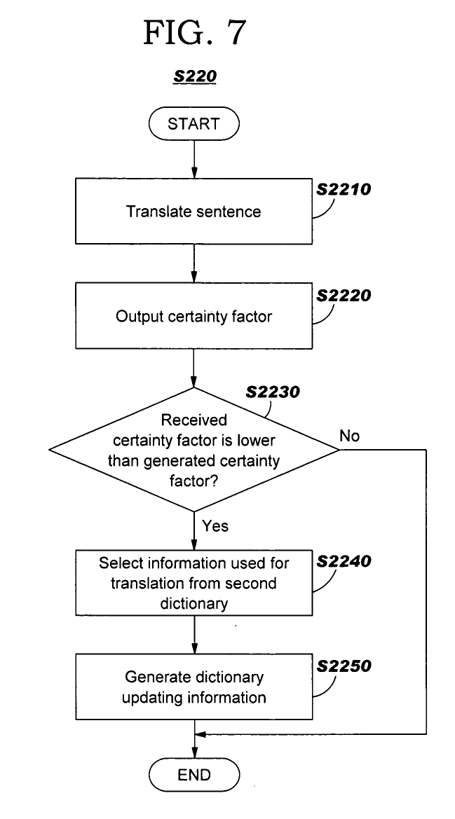

FIG. 7 shows details of S220. If the dictionary updating information generating unit 230 receives the conversion source information having the certainty factor which is lower than the reference certainty factor, as the conversion processing information from the conversion processing information transmitting unit 140, it transmits the sentence to be translated as an example of the conversion source information to the translation unit 220. When the translation unit 220 receives it, it translates the sentence using the second dictionary (S2210). Then, the translation unit 220, according to the method as explained in FIG. 6, calculates and outputs the certainty factor of the translation (S2220). If the certainty factor associated with the conversion source information and received from the terminal 100, is lower than the certainty factor in the case of being translated by the translation unit 220 (S2230: YES), the dictionary updating information generating unit 230 selects the information used for the translation of the conversion source information by the translation unit 220, from the second dictionary (S2240), and generates the information as the dictionary updating information (S2250). For example, the dictionary updating information generating unit 230 selects data of the compound words including the words used for the translation or data of rules for integrating the phrases used in the parsing, from the second sub-dictionaries among the information used for the translation of the conversion source information by the translation unit 220, and generates them as the dictionary updating information.

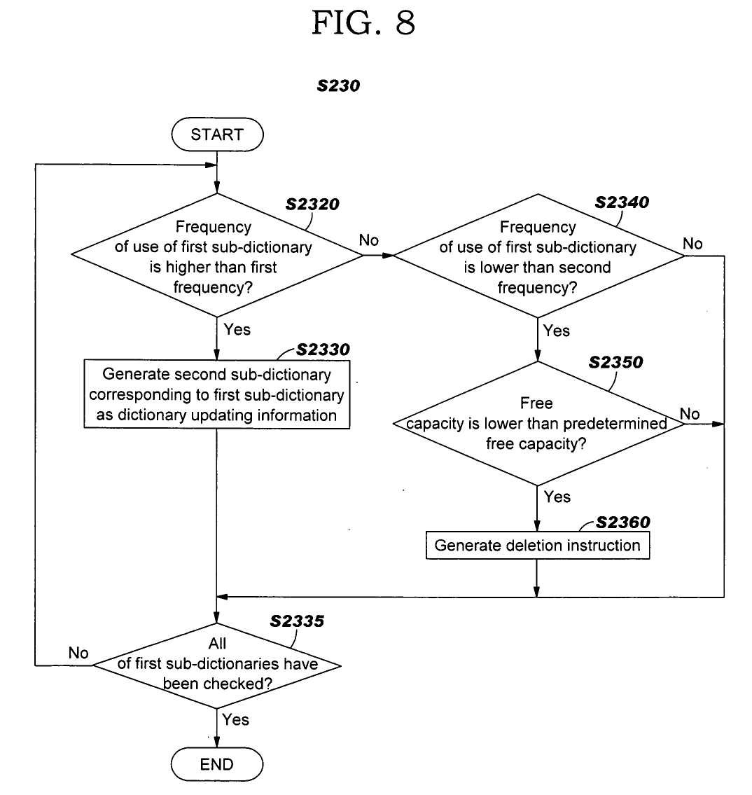

FIG. 8 shows an example of details of S230 shown in FIG. 4. The dictionary updating information generating unit 230 determines whether or not the frequency of use of the one of the first sub-dictionaries is higher than the predefined first frequency (S2320). If the frequency of use of the one of the first sub-dictionaries is higher than the first frequency (S2320: YES), the dictionary updating information generating unit 230 generates the second sub-dictionary corresponding to the one of the first sub-dictionaries as the dictionary updating information (S2330). As another example, the dictionary updating information generating unit 230 may also determine whether or not the free capacity indicated by the free capacity information is smaller than a predefined capacity. In this case, if the free capacity is smaller than the predefined capacity, the dictionary updating information generating unit 230 may not generate the dictionary updating information. Then if the dictionary updating information generating unit 230 has checked the frequencies of use with respect to all of the first sub-dictionaries (S2335: YES), it completes the process. If the dictionary updating information generating unit 230 has not checked yet the frequencies of use with respect to all of the first sub-dictionaries (S2335: NO), it returns the process to S2320, and executes the process similarly with respect to other first sub-dictionary.

On the other hand, if the frequency of use of the one of the first sub-dictionaries is not higher than the first frequency (S2320: NO), the dictionary updating information generating unit 230 determines whether or not the above described frequency of use of the one of the first sub-dictionaries is lower than a predefined second frequency (S2340). If the frequency of use of the one of the first sub-dictionaries is not lower than the second frequency (S2340: NO), the dictionary updating information generating unit 230 passes the process to S2335. If the frequency of use of the one of the first sub-dictionaries is lower than the second frequency (S2340: YES), the dictionary updating information generating unit 230 determines whether or not the free capacity indicated by the free capacity information is smaller than the predefined capacity (S2350). If the free capacity is larger than the predefined capacity (S2350: NO), the dictionary updating information generating unit 230 passes the process to S2335. On condition that the free capacity is smaller than the predefined capacity (S2350: YES), the dictionary updating information generating unit 230 generates the deletion instruction indicating to delete the above described one of the first sub-dictionaries, as the dictionary updating information, and passes the process to S2335.

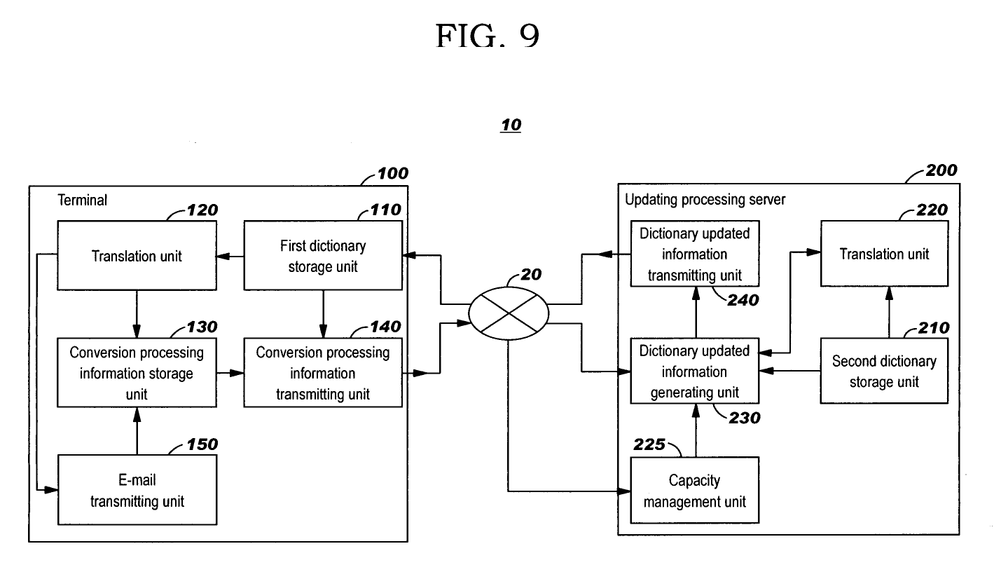

FIG. 9 shows a functional block diagram of the dictionary updating system 10 in a variation of this embodiment. The terminal 100 in this variation further has an E-mail transmitting unit 150 in addition to the terminal 100 as shown in FIG. 1. Other configurations with which the dictionary updating system 10 is provided are approximately the same as those of the dictionary updating system 10 in FIG. 1, thereby only differences will be described.

The E-mail transmitting unit 150 receives the conversion destination information to which the conversion source information has been translated, from the translation unit 120, and in response to the instruction from the user and the like, transmits the conversion destination information as the E-mail to an external terminal. The E-mail transmitting unit 150 further transmits this E-mail to the conversion processing information storage unit 130, as well as notifies the conversion processing information transmitting unit 140 that the E-mail has been transmitted. The conversion processing information storage unit 130 stores the E-mail as the conversion processing information.

Then, each time the conversion processing information transmitting unit 140 receives the notification that the E-mail has been transmitted, that is, each time the E-mail is transmitted by the E-mail transmitting unit 150, the conversion processing information transmitting unit 140 obtains the conversion processing information including the E-mail from the conversion processing information storage unit 130, and transmits it as the E-mail to the dictionary updating information generating unit 230. For example, the conversion processing information transmitting unit 140 specifies a recipient of the E-mail inputted by the user, as a destination of the E-mail (TO field), and specifies an E-mail address associated with the updating processing server 200, as a destination of a carbon copy of the E-mail (CC field). Then the dictionary updating information generating unit 230 creates the dictionary updating information according to the received E-mail, and transmits it to the first dictionary storage unit 110.

It should be noted that the conversion processing information transmitting unit 140 desirably generates the conversion processing information by exchanging an word order among the plurality of words in the sentence in the E-mail, because it is possible to prevent contents of the E-mail from being eavesdropped even if the network 20 is an open network shared by general public, or if the updating processing server 200 is an ASP server used by the general public. Furthermore, even if the updating processing server 200 receives the E-mail having the sentence in which the word order has been exchanged, it may recognize appropriately frequencies of appearance of the words and the like. In other words, the updating processing server 200 may receive the conversion processing information without executing any additional process such as an encryption decoding process, with keeping secrets of the contents to some degree.

In this way, each time the user transmits the E-mail created with the translation, the terminal 100 transmits the above described E-mail to the updating processing server 200. Therefore, the user of the terminal 100 may update the first dictionary without executing any cumbersome operation in order to update the first dictionary.

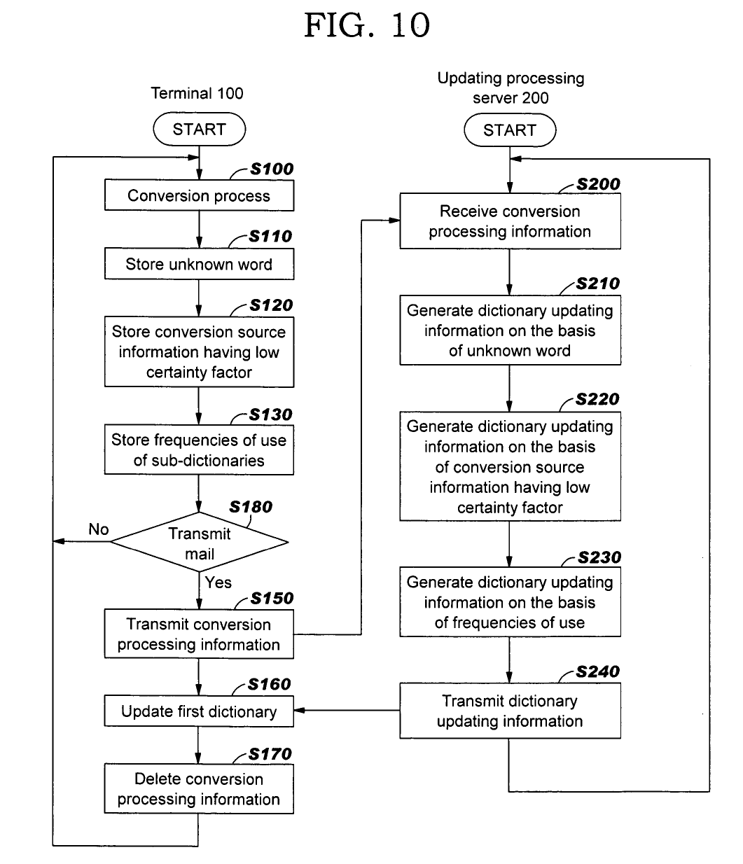

FIG. 10 shows an operational flow of the dictionary updating system 10 in the variation. The operational flow in this variation has S180 instead of S140 in the operational flow shown in FIG. 4. Other configurations are approximately the same as those of the operational flow shown in FIG. 4, thereby only differences will be described.

The E-mail transmitting unit 150 determines whether or not an instruction for transmitting a mail is received from the user (S180). If the instruction for transmitting the mail is received (S180: YES), the conversion processing information transmitting unit 140 transmits the E-mail generated with the translation to the updating processing server 200 (S150). The conversion processing information transmitting unit 140 further may transmit the conversion processing information stored in the conversion processing information storage unit 130 to the updating processing server 200.

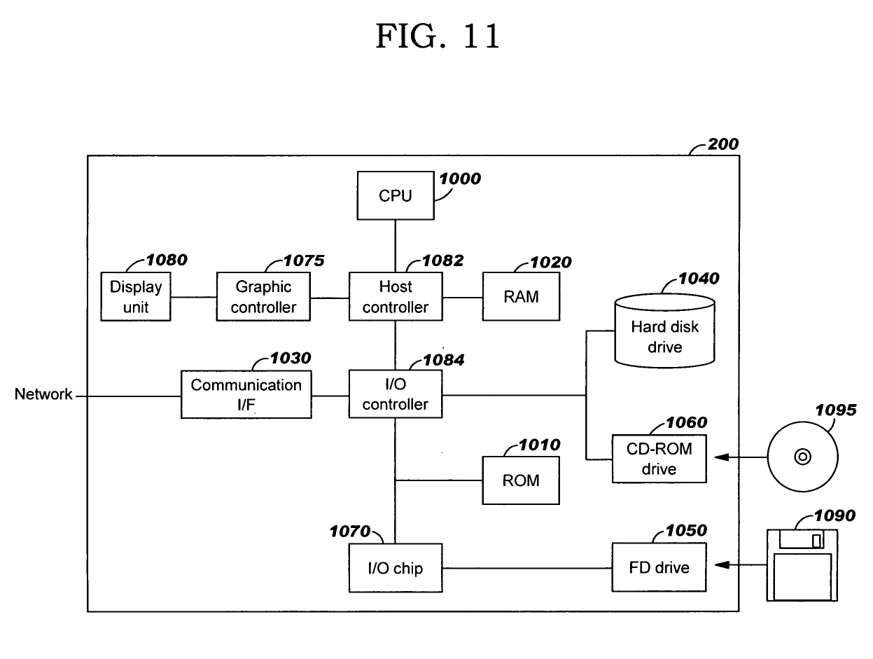

FIG. 11 shows an example of a hardware configuration of the updating processing server 200 according to this embodiment and the variation. The updating processing server 200 according to this embodiment is provided with a CPU peripheral section having a CPU 1000, a RAM 1020, a graphic controller 1075 and a display unit 1080 which are interconnected by a host controller 1082, an input/output section having a communication interface 1030, a hard disk drive 1040 and a CD-ROM drive 1060 which are connected to the host controller 1082 by an input/output controller 1084, and a legacy input/output section having a ROM 1010, a flexible disk drive 1050 and an input/output chip 1070 which are connected to the input/output controller 1084.

The host controller 1082 connects the RAM 1020, the CPU 1000 for accessing the RAM 1020 at a high transfer rate, and the graphic controller 1075. The CPU 1000 operates on the basis of a program stored in the ROM 1010 and the RAM 1020 to control the respective sections. The graphic controller 1075 obtains image data to be generated on a frame buffer, which is provided within the RAM 1020 by the CPU 1000 and the like, and displays it on the display unit 1080. Alternatively, the graphic controller 1075 may also include the frame buffer therein for storing the image data generated by the CPU 1000 and the like.

The input/output controller 1084 connects the host controller 1082, the communication interface 1030 which is a relatively fast input/output device, the hard disk drive 1040 and the CD-ROM drive 1060. The communication interface 1030 communicates with other devices via the network. The hard disk drive 1040 stores the program and the data used by the updating processing server 200. The CD-ROM drive 1060 reads the program or the data from a CD-ROM 1095, and provides it to the RAM 1020 via the input/output controller 1084.

In addition, the input/output controller 1084 is connected with the ROM 1010 and relatively slow input/output devices such as the flexible disk drive 1050, the input/output chip 1070 and the like. The ROM 1010 stores a boot program executed by the CPU 1000 when the updating processing server 200 is started, the program which is dependent on hardware of the updating processing server 200 and the like. The flexible disk drive 1050 reads the program or the data from a flexible disk 1090, and provides it to the RAM 1020 via the input/output controller 1084. The input/output chip 1070 connects the flexible disk 1090, and various kinds of input/output devices via, for example, a parallel port, a serial port, a keyboard port, a mouse port and the like.

The program to be provided to the updating processing server 200 is stored in a recording medium such as the flexible disk 1090, the CD-ROM 1095, an IC card and the like, and is provided by the user. The program is read from the recording medium, installed into the updating processing server 200 via the input/output controller 1084, and executed in the updating processing server 200.

The program to be installed and executed in the updating processing server 200 includes a first dictionary storage module, a translation module, a conversion processing information storage module, a conversion processing information transmitting module and an E-mail transmitting module. Description of operations which the respective modules work the updating processing server 200 to execute, is omitted, because the operations are the same as those of the corresponding members in the updating processing server 200 as described in FIGS. 1 to 10.

The programs and the modules as described above may also be stored in an external recording medium. As the recording medium, in addition to the flexible disk 1090 and the CD-ROM 1095, it is possible to use an optical recording medium such as a DVD or a PD, a magnet-optic recording medium such as a MD, a tape medium, a semiconductor memory such as the IC card, and the like. Also, the storage device such as the hard disk, the RAM or the like, which are provided in a server system connected to a private communication network or the Internet, may be used as the recording medium, and the program may be provided to the updating processing server 200 via the network.

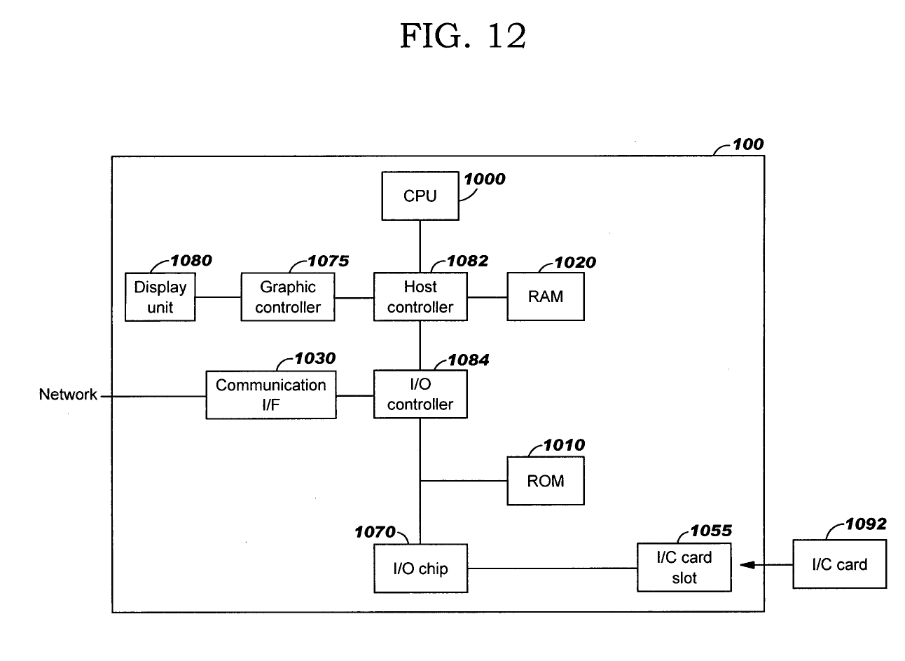

FIG. 12 shows an example of a hardware configuration of the terminal 100 according to this embodiment and the variation. Since members provided in the terminal 100 are approximately the same as the respective members having the same reference numerals in FIG. 11, thereby only differences will be described. The terminal 100 may not be provided with the hard disk drive 1040, the CD-ROM drive 1060 and the flexible disk drive 1050. The terminal 100 may also further be provided with an IC card slot 1055, in addition to the configuration shown in FIG. 11. The terminal 100 may also further be provided with a wireless communication unit connected to the communication interface 1030. The program for realizing the terminal 100 may be stored in the recording medium and provided to the terminal 100, or may be installed from the updating processing server 200 via the network. The program to be installed and executed in the terminal 100 includes a second dictionary storage module, the translation module, a capacity management module, a dictionary updating information generating module and a dictionary updating information transmitting module. Description of operations which the respective modules work the terminal 100 to execute, is omitted, because the operations are the same as those of the corresponding members in the terminal 100 as described in FIGS. 1 to 10.

The program and the modules as described above may also be stored in the external recording medium. As the recording medium, in addition to the flexible disk and the CD-ROM, it is possible to use the optical recording medium such as the DVD or the PD, the magnet-optic recording medium such as the MD, the tape medium, the semiconductor memory such as an IC card 1092, and the like. Also, the storage device such as the hard disk, the RAM or the like, which are provided in the server system connected to the private communication network or the Internet, may be used as the recording medium, and the program may be provided to the terminal 100 via the network.

As will be apparent from the above description, the dictionary updating system 10 may update automatically the first dictionary in the terminal 100 on the basis of the conversion processing information indicating a processing result of the translation. For example, even if the user executes only the translation process or the mail transmitting process, the dictionary updating system 10 may update the first dictionary in the terminal 100 using the second dictionary in the updating processing server 200 to improve the precision of translation thereafter.

In addition, the dictionary updating system 10 may customize the first dictionary appropriately depending on the user of the terminal 100. Particularly, since the dictionary updating system 10 updates the first dictionary by generating the conversion processing information each time the user executes the translation, it is possible to improve the quality of translation each time the user repeats the translation using the first dictionary.

Accordingly, even if the terminal 100 is the portable communication terminal and the like such as the PDA and the like, and stores the first dictionary in a relatively small storage area, the dictionary updating system 10 may improve the quality of translation by updating the first dictionary gradually. In other words, since the storage area in the terminal 100 may be reduced without lowering the quality of translation, thereby it is possible to downsize the terminal 100 and reduce electrical power consumption of the terminal 100.

According to the above described embodiments, it is possible to realize a dictionary updating system, an updating processing server, a terminal, a control method, a program and a recording medium as will be described below.

Heretofore, though the present invention has been described by means of the embodiments, a technical range of the present invention is not limited to the range described in the above described embodiments. It is possible to add various modification or improvement to the above described embodiments. It is apparent from the description of the claims that the embodiments added with such modification or improvement may also be included in the technical range of the present invention. For example, the terminal 100 may not be provided with the translation unit 120. The terminal 100 in this case is, for example, a terminal for providing the dictionary for the translation to another terminal as an additional function. In other words, the terminal of the first dictionary storage unit 110 may also store the first dictionary to be used by the translation unit provided in another terminal.

As will be apparent from the above description, according to the present invention, it is possible to update appropriately the dictionaries provided in the terminal.

1. A dictionary updating system comprising a terminal having a first dictionary for converting input conversion source information to conversion destination information and an updating processing server for updating said first dictionary of said terminal via a network,
said terminal, comprising:
first dictionary storage means for storing said first dictionary;
conversion processing information storage means for storing conversion processing information obtained during processing of converting said conversion source information to said conversion destination information on the basis of said first dictionary; and
conversion processing information transmitting means for transmitting said conversion processing information to said updating processing server,
said updating processing server, comprising:
dictionary updating information generating means for generating dictionary updating information for updating said first dictionary on the basis of said conversion processing information; and
dictionary updating information transmitting means for transmitting said dictionary updating information to said terminal.

2. The dictionary updating system according to claim 1, wherein said updating processing server further comprises second dictionary storage means for storing a second dictionary for converting the conversion source information to the conversion destination information,
wherein said dictionary updating information generating means selects information to be added to said first dictionary, from said second dictionary, on the basis of said conversion processing information, and generates the information as said dictionary updating information.

3. The dictionary updating system according to claim 2, wherein said first dictionary storage means stores said first dictionary for translating said conversion source information written in a first language to said conversion destination information written in a second language;
said conversion processing information storage means stores information for associating said conversion source information with a certainty factor of a translation result, as said conversion processing information;
said updating processing server further comprises translation means for translating said received conversion source information by means of said second dictionary and outputting the certainty factor of the translation; and
if said received certainty factor associated with said conversion source information is lower than the certainty factor in the case of being translated by said translation unit, said dictionary updating information generating means selects the information used for the translation of said conversion source information by said translation means, from said second dictionary, and generates the information as said dictionary updating information.

4. The dictionary updating system according to claim 3, wherein if said certainty factor of the translation in said conversion source information is lower than a predefined reference certainty factor, said conversion processing information storage means stores said conversion source information.

5. The dictionary updating system according to claim 2, wherein said conversion processing information storage means stores said conversion source information which has not been able to be converted with said first dictionary, as said conversion processing information; and
said dictionary updating information generating means selects the conversion destination information corresponding to said conversion processing information as said dictionary updating information from said second dictionary.

6. The dictionary updating system according to claim 5, wherein said dictionary updating information generating means further selects the conversion destination information on compound words including said conversion processing information, from said second dictionary.

7. The dictionary updating system according to claim 2, wherein said first dictionary storage means stores a plurality of first sub-dictionaries as said first dictionary;
said conversion processing information storage means stores respective frequencies of use of said plurality of first sub-dictionaries as said conversion processing information;
said conversion processing information transmitting unit transmits the respective frequencies of use of said plurality of first sub-dictionaries as said conversion processing information to said updating processing server;
said second dictionary storage means stores a plurality of second sub-dictionaries associated with said plurality of first sub-dictionaries respectively, as said second dictionary; and
if said frequency of use of one of the first sub-dictionaries is higher than a predefined first frequency, said dictionary updating information generating means generates one of said second sub-dictionaries corresponding to said one of the first sub-dictionaries, as said dictionary updating information.

8. The dictionary updating system according to claim 7, wherein said second dictionary includes said first dictionary; and
if said frequency of use of another one of said first sub-dictionaries is lower than a predefined second frequency, said dictionary updating information generating means generates a deletion instruction for deleting said another one of the first sub-dictionaries, as said dictionary updating information.

9. The dictionary updating system according to claim 8, wherein said updating processing server further comprises a capacity management means for managing capacity information indicating a free capacity in a storage device provided in said terminal; and
said dictionary updating information generating means generates said deletion instruction further on condition that the free capacity indicated by said free capacity information is smaller than a predefined capacity.

10. The dictionary updating system according to claim 1, wherein said terminal further comprises:
an E-mail transmitting means for transmitting said conversion destination information to which said conversion source information has been converted, to an external terminal via an E-mail;
wherein said conversion processing information transmitting means further transmits said E-mail as said conversion processing information to said updating processing server each time said E-mail is transmitted; and
said dictionary updating information transmitting means creates said dictionary updating information on the basis of said E-mail, and transmits it to said terminal.

11. The dictionary updating system according to claim 10, wherein said conversion processing information transmitting means generates said conversion processing information by exchanging an word order among a plurality of words in a sentence in said E-mail.

12. The dictionary updating system according to claim 1, wherein said conversion processing information transmitting means deletes said conversion processing information stored in said conversion processing information storage means upon transmitting said conversion processing information to said updating processing server.

13. A terminal having a first dictionary for converting input conversion source information to conversion destination information and causing an external updating processing server to update the first dictionary, said terminal comprising:
conversion processing information storage means for storing conversion processing information obtained during processing of converting said conversion source information to said conversion destination information on the basis of said first dictionary;
conversion processing information transmitting means for transmitting said conversion processing information to said updating processing server; and
first dictionary storage means for storing said first dictionary and updating said first dictionary upon receiving dictionary updating information for updating said first dictionary from said updating processing server.

14. The terminal according to claim 13, further comprising translation means for translating said conversion source information written in a first language to said conversion destination information written in a second language, by means of said first dictionary,
wherein said conversion processing information transmitting means transmits information for associating said conversion source information with a certainty factor of a translation result, as said conversion processing information, to said updating processing server; and
said first dictionary storage means updates said first dictionary on the basis of said dictionary updating information returned by said updating processing server, in response to said certainty factor.

15. The terminal according to claim 13, wherein said conversion processing information storage means stores said conversion source information which has not been able to be converted with said first dictionary, as said conversion processing information; and
said first dictionary storage means receives the conversion destination information corresponding to said conversion processing information as said dictionary updating information from said updating processing server, and updates said first dictionary by adding said conversion destination information.

16. The terminal according to claim 13, wherein said first dictionary storage means stores a plurality of first sub-dictionaries as said first dictionary;
said conversion processing information storage means stores respective frequencies of use of said plurality of first sub-dictionaries as said conversion processing information;
said conversion processing information transmitting means transmits the respective frequencies of use of said plurality of first sub-dictionaries as said conversion processing information to said updating processing server; and
said first dictionary storage means receives another one of sub-dictionaries associated with one of said first sub-dictionaries having the frequency of use which is higher than a predefined first frequency, from said updating processing server, and updates said first dictionary by adding said another one of sub-dictionaries.

17. An updating processing server for transmitting dictionary updating information for updating a first dictionary for converting input conversion source information to conversion destination information to a terminal having the first dictionary, comprising:
dictionary updating information generating means for receiving conversion processing information obtained during processing of converting said conversion source information to said conversion destination information on the basis of said first dictionary from said terminal and generating dictionary updating information for updating said first dictionary on the basis of the conversion processing information; and
dictionary updating information transmitting means for transmitting said dictionary updating information to said terminal to update said first dictionary.

18. A method of controlling a terminal having a first dictionary for converting input conversion source information to conversion destination information and an updating processing server for updating said first dictionary of said terminal via a network, said method comprising the steps of:
causing said terminal to store said first dictionary;
causing said terminal to store conversion processing information obtained during processing of converting said conversion source information to said conversion destination information on the basis of said first dictionary;
causing said terminal to transmit said conversion processing information to said updating processing server;
causing said updating processing server to generate dictionary updating information for updating said first dictionary on the basis of said conversion processing information; and
causing said updating processing server to make said terminal transmit said dictionary updating information.

19. A program for enabling a computer to serve as an updating processing server for transmitting dictionary updating information for updating a first dictionary for converting input conversion source information to conversion destination information to a terminal having the first dictionary, said program comprising:
dictionary updating information generating subprocesses for generating dictionary updating information for updating said first dictionary on the basis of said conversion processing information upon receiving conversion processing information obtained during processing of converting said conversion source information to said conversion destination information on the basis of said first dictionary from said terminal; and
dictionary updating information transmitting subprocesses for transmitting said dictionary updating information to said terminal to update said first dictionary.

20. A program for enabling a computer to serve as a terminal having a first dictionary for converting input conversion source information to conversion destination information and causing an external updating processing server to update the first dictionary, said program comprising:
conversion processing information storage subprocesses for storing conversion processing information obtained during processing of converting said conversion source information to said conversion destination information on the basis of said first dictionary;
conversion processing information transmitting subprocesses for transmitting said conversion processing information to said updating processing server; and
first dictionary storage subprocesses for storing said first dictionary and updating said first dictionary upon receiving dictionary updating information for updating said first dictionary from said updating processing server.
